(19) United States
(12) Patent Application Publication
(10) Pub. No.: US 2003/0164904 A1
(43) Pub. Date: Sep. 4, 2003

(54) Backlit LCD device with reduced power consumption

(75) Inventors: Mika Grohn, Oulu (FI); Heikki Alakontiola, Oulu (FI)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/086,308

(22) Filed: Mar. 1, 2002

(51) Int. Cl. G02F 1/1335

(52) U.S. Cl. 349/65

(57) ABSTRACT

A backlit liquid crystal display (LCD) device has a fluorescent layer inserted between the light source and the light guide. The fluorescent layer is stimulated by each light pulse from the light source, causing the fluorescent layer to emit light. After the end of each light pulse, the fluorescent layer continues to emit light at a particular intensity and frequency for a certain period. In addition, the light emitted by the fluorescent layer serves to balance out the spectrum of light emitted by the light source.

### FIELD OF THE INVENTION

The present invention relates generally to a backlit liquid crystal display (LCD) device and specifically to a system for decreasing the flickering and other effects caused by pulsing the light source in an LCD device.

### BACKGROUND OF THE INVENTION

Liquid crystal display (LCD) flat panels consist of many individual pixels, where each pixel may be comprised of one or more liquid crystal cells. Each liquid crystal cell operates as a shutter, allowing light to go through a pixel (or sub-pixel) when “open” and not allowing light to go through a pixel (or sub-pixel) when “closed”. In FIG. 1, light 101 is entering a liquid crystal cell 100 from the right-hand side. Light 101 can be viewed as having two components: a horizontally polarized component (H 102) and a vertically polarized component (V 103). The first polarizer 110 only allows vertically polarized component V 103 to exit, thus blocking horizontally polarized component H 102. V 103 then enters liquid crystal segment 120. Because of the properties of the liquid crystal and the construction of liquid crystal segment 120, the vertically polarized light V 103 is twisted inside the liquid crystal segment 120, so that horizontally polarized light H 104 exits liquid crystal segment 120. This horizontally polarized light H 104 then leaves the liquid crystal cell 100 through second polarizer 130, which only allows horizontally polarized light through.

FIG. 2 shows the same liquid crystal cell 100 as FIG. 1; however, voltage 250 is being applied to liquid crystal segment 120 in FIG. 2. When voltage is applied to liquid crystal segment 120, the molecules of the liquid crystal arrange themselves along the electric field. Because of this re-alignment, when vertically polarized component V 103 enters liquid crystal segment 120, it is not twisted, but merely passes through unchanged. Thus, vertically polarized component V 103 exits liquid crystal segment 120. Second polarizer 130 blocks vertically polarized light V 103 from passing through because second polarizer 130 only allows through horizontally polarized light. In other words, when the voltage is on, the shutter is closed, and when the voltage is off, the shutter is open. This type of configuration is called a positive image LCD. If both the first and second polarizers 110 and 130 allowed vertically polarized light through, then the effect would be reversed: when the voltage is on, the shutter is open, and when the voltage is off, the shutter is closed. This type of configuration is called a negative image LCD.

However, liquid crystal cells, by themselves, emit no light. Because of this, flat panel displays using liquid crystal cells need a light source. There are two sources for lighting liquid crystal displays (LCDs): reflected light (i.e., where ambient light passes through the liquid crystal cell and is reflected from a reflective surface in back of the liquid crystal cell) and back lighting (i.e., where a light source is provided in back of the liquid crystal cell).

Furthermore, liquid crystal cells with a light source cannot provide multiple colors to the viewer. The term “full color” will be used herein to signify the capability of showing a variety of colors which substantially represent the colors of the visible spectrum. In order to create the colors of the visible spectrum, each color is broken down into percentages of single-color components. Typically, the single color components are red (R), green (G), and blue (B). For example, the color purple may be about x% red (R), about y% green (G), and about z% blue (B). When creating a full color pixel, it must be constructed of single color sub-pixels of each color component.

FIG. 3, one can see a grouping of individual single-color sub-pixels together to form a typical single full color pixel 300. Individual full color pixel 300 is comprised of 16 single color sub-pixels. Each sub-pixel is typically a color filter which has its own liquid crystal segment which opens and closes depending on whether voltage is applied to the sub-pixel. Each full color pixel shows a different color depending on the different combinations of sub-pixels which are formed by turning individual sub-pixels on or off. Because of the pattern of RGB sub-pixels, this type of display is sometimes called a mosaic display. Although this exemplary full color pixel is a square of 16 sub-pixels, a pixel can be any number of sub-pixels in any viable shape. Furthermore, the order of colors may be any workable configuration. There are other ways of breaking down colors of the visible spectrum besides into RGB components, and the present invention, as described below, is not limited to LCD color displays using RGB sub-pixels.

An exploded three-dimensional cross-section of the layers in an exemplary single full color pixel 400 of a backlit color LCD panel display is shown in FIG. 4. On the bottom layer, linear light source 405 provides the back lighting. Light source 405 may be a cold cathode fluorescent lamp, a hot cathode fluorescent lamp, a light emitting diode (LED), or an electroluminescent element. Next to light source 405 is light guide 410, which is used to distribute light from light source 405 across the back of the LCD panel display. Light guide 410 is typically made of glass, or a substantially transparent polymer, such as polymethyl methacrylate (PMMA), polystyrene, styrene-acrylonitrile, or polycarbonate. There may be a reflective surface placed beneath light guide 410. Light from light source 405 enters light guide 410 through its side faces and is distributed through light guide 410 by internal reflection. Diffuser 420 further balances the intensity distribution of light backlighting the display. When the Light Source 405 lies next to Light Guide 410 so that light enters Light Guide 410 through its edge (as it is in FIG. 4), the LCD device is an edge light or side light type LCD device. When the light source lies underneath the light guide or diffuser (if there is no light guide layer), the LCD device is a direct light type LCD device.

First polarizer 430 only allows light with a first polarization direction through. Above first polarizer 430 is rear substrate 440. Rear substrate 440 is typically made of glass and has the addressing elements for the liquid crystal layer 450. Specifically, rear substrate 440 has an array 441 of thin film transistors (TFT), each of which turns an individual sub-pixel on or off. Because switching elements (such as TFTs) are active elements, this type of LCD device is called an active matrix display. By contrast, a passive matrix display has electrodes on both sides of liquid crystal layer 450. One side, or substrate, would contain columns of electrodes and the other side, or substrate, would have the rows of electrodes. To turn on or off a particular sub-pixel in a passive matrix display, the appropriate column containing that sub-pixel's first electrode is charged and the particular row containing that sub-pixel's second electrode is grounded. The present invention, as described below, is not limited to either passive or active matrix displays.

Front substrate 460 is typically made of glass or plastic and has a color filter matrix 461 for the individual sub-pixels. Color filter matrix 461 has the 16 single color sub-pixels of FIG. 3's exemplary full color pixel. Each transistor in TFT array 441 matches a color filter in color filter matrix 461. Lastly, the light exits through second polarizer 470 which only allows light with a second polarization through. Because first and second polarizers 430 and 470 have different polarization directions, the display shown here is a positive image display.

Although the layers in FIG. 4 are shown in a particular order and the sub-pixels in FIG. 4 are shown in a particular configuration, the order of the layers and the configuration of the sub-pixels could be varied, as is known to one skilled in the art. For example, color filter matrix 461 can be placed below TFT array 441 rather than above. Furthermore, some layers and materials may be substituted for one another. Additional layers may be added, such as brightness enhancement filters, and some of the present layers may be removed, such as the color filter matrix (in a black and white display). The possible variations in the configuration of sub-pixels have been discussed above in reference to FIG. 3.

Some LCD display examples that illustrate the variations in layering and material follow. In U.S. Pat. No. 5,926,239 to Kumar et al. (hereinafter referred to as the “Kumar”), the color filter layer 460 is completely removed and a faceplate of individual colored phosphors (corresponding to the individual colored sub-pixels) is set as the bottom layer. This bottom phosphor layer is excited by an appropriate source, e.g., a glow discharge from an intensity lamp, ultraviolet rays from a plasma, a field emitting device where the phosphors are the anode, etc. Another example is U.S. Pat. No. 5,883,684 to Millikan et al. (hereinafter referred to as “Millikan”), in which a translucent fluorescent film is used as the diffuser layer above the light guide. This fluorescent film layer provides a means of colored backlighting. In addition, the ambient light from the environment around the display is absorbed by the fluorescent layer and re-emitted.

In U.S. Pat. No. 5,982,092 to Chen (hereinafter referred to as “Chen”), a fluorescent pigment layer beneath the light guide receives blue or ultra-violet light from the light guide and fluoresces. The LEDs used as a white light source in backlit LCD displays do not emit pure white light, but rather a spectrum of light with a narrower bandwidth and uneven intensity (e.g., the blue part of the spectrum is stronger than the rest of the spectrum, resulting in blue-white light). The fluorescent layer in Chen tries to solve this problem by emitting light to equalize the spectrum produced by the light source. Specifically, the fluorescent layer produces yellow light. This yellow light combines with the blue light from the LEDs in order to form a more balanced spectrum (which resembles pure white light more closely) for backlighting the LCD.

Because such variations are not directly related to the present invention, the upper layers 430-470 in FIG. 4 need not be considered in the description, and may be simplified conceptually to one single layer, as is shown in FIG. 5. FIG. 5 is a cross-section of an LCD device, where liquid crystal matrix 550 represents any possible configuration of upper layers in a backlit LCD device. FIG. 5 is a generalized representation of an LCD device, and is not limited to color or grayscale displays. Furthermore, the LCD device in FIG. 5 may represent a segment with a single pixel or multiple pixels. In the roughly rectangular shaped light guide 410, the intensity of light emitted upwards from the top surface 530 of light guide 410 attenuates as the distance from light source 405 increases. This is mainly because the incident light from light source 405 which strikes (and is reflected from) the internal bottom surface 540 of light guide 410 decreases as the distance from light source 405 increases.

Referring to FIG. 6, an LCD device has a light guide 600 formed into a double wedge shaped cross section. The decreasing width of light guide 600 as the distance from light source 405 increases causes more incident light to reflect off the bottom surface 610 of light guide 600. Thus, the intensity distribution of light exiting the top surface of light guide 600 is more evenly balanced than light guide 410 in FIG. 5. A double wedge shape is used rather than a single wedge shape because it is assumed there is a neighboring light source 670 on the opposite side of light guide 600 from light source 405. The assumption is that the LCD device shown in any of the drawings is just one element in a flat panel screen which may be composed of thousands of such elements in a grid pattern. Similarly, there would be a pattern of light sources lighting up the LCD elements. In FIG. 6, there are light sources shown on two edges of the pixel. It would also be possible to have a light source on only one edge, on three edges, on all four edges, or possibly no edges (if there is more than two pixels between light sources).

In many backlit LCD devices, the light source is pulsed (turned on and off) with a fairly short duty cycle in order to save power, i.e., the period of time the light source is on is fairly short in comparison with the period of time the light source is off in one cycle. This is particularly important in applications (e.g., laptop computers, personal digital assistants (PDAs), cellular telephones, etc) where the LCD device must run on a limited supply of power, e.g., a battery. Because the human eye can detect pulsing that is below about 16 Hz and can be irritated by light which is pulsed below about 25 Hz, the pulse rate must be maintained above about 25 Hz. However, maintaining such high frequency pulsing consumes more power, thus decreasing the power savings caused by the pulsing.

One proposed solution to this problem is in U.S. Pat. No. 5,815,228 to Flynn (hereinafter referred to as “Flynn”). Similarly to the Millikan LCD display described above, Flynn has an added fluorescent layer, which is used to extend the period of time the LCD backlight remains lit. This fluorescent layer is applied to the bottom of the rear polarizer of the LCD (i.e., to the bottom of liquid crystal matrix 550). The fluorescent material in the layer is excited by both ambient light and light from the light guide. When the pulse is decreasing in intensity, the stimulated fluorescent material continues to emit light. This, in effect, results in the pulse becoming longer in time or, in other words, in the backlight remaining lit for a longer period of time. This allows for lower frequency pulsing, because the lower frequency will not be detected by the human eye. With the lower frequency pulsing comes a savings in energy.

However, Flynn requires an entire horizontal layer of the LCD display to consist of fluorescent material. Furthermore, if this fluorescent layer has any anomalies (i.e., if it is not completely homogeneous), the spatial distribution of light intensity would be uneven over the display.

Therefore, there is a need for an LCD device which can pulse its light source at a lower rate to save power, but will not cause flickering or other effects discernible and/or irritating to the human eye. Moreover, this inventive LCD device should not require an entire horizontal layer of fluorescent material which uses a great deal of fluorescent material and risks an uneven spatial distribution of light intensity.

### SUMMARY OF THE INVENTION

One object of the invention is to provide a backlit LCD device which uses a light source that is pulsed at a lower rate than conventional light sources in backlit LCD devices.

Another object of the invention is to provide a light source which consumes less power than conventional light sources in a backlit LCD device.

Another object of the invention is to provide a backlit LCD device which uses a light source that is pulsed at a lower rate than conventional light sources in backlit LCD devices, but does not cause any flickering or other effects discernible and/or irritating to the human eye.

Yet another object of the invention is to provide a low power LCD device which is appropriate for use in battery powered portable devices, such as PDAs and cellular phones.

Still another object of the present invention is to provide a backlit LCD device which does not require an entire horizontal layer of fluorescent material which uses a great deal of fluorescent material and may cause an uneven spatial distribution of light intensity.

A still further object of the present invention is to provide a backlit LCD device with a layer of fluorescent material which balances an uneven spectral distribution of light intensity emitted by the light source.

These and other objects are accomplished by the present invention in which a fluorescent layer is inserted between the light source and the light guide of a backlit LCD device. The fluorescent layer is stimulated by a pulse of light from the light source, causing it to emit light. After the light source is turned off, the fluorescent layer continues to emit light at a particular intensity and frequency for a certain period. In addition, the material in the fluorescent layer can be chosen so that the fluorescent light balances out the uneven spectrum of light emitted by the light source.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 shows a conventional liquid crystal cell in a positive image LCD device with no voltage being applied to the liquid crystal;

FIG. 2 shows a conventional liquid crystal cell in a positive image LCD device with voltage being applied to the liquid crystal;

FIG. 3 is a schematic representation of a exemplary conventional full color pixel in a mosaic display;

FIG. 4 is an exploded three-dimensional cross-section of the layers in an exemplary single full color pixel 400 of a conventional backlit color LCD panel display;

FIG. 5 is a simplified block diagram of the layers in a conventional backlit LCD panel display;

FIG. 6 is a simplified block diagram of the layers in a conventional backlit LCD panel display with a double wedge shaped light guide;

FIG. 7 is a simplified block diagram of the layers in a backlit LCD panel display according to a preferred embodiment of the present invention;

FIG. 8 is a schematic representation of the pulses a light source emits in a conventional LCD device;

FIG. 9 is a schematic representation of the pulses a light source emits in an LCD device according to an embodiment of the present invention;

FIG. 10 is a simplified block diagram of the layers in a backlit LCD panel display with a double wedge shaped light guide according to another preferred embodiment of the present invention; and

FIG. 11 is a simplified block diagram of the layers in a transfection backlit LCD panel display according to yet another preferred embodiment of the present invention.

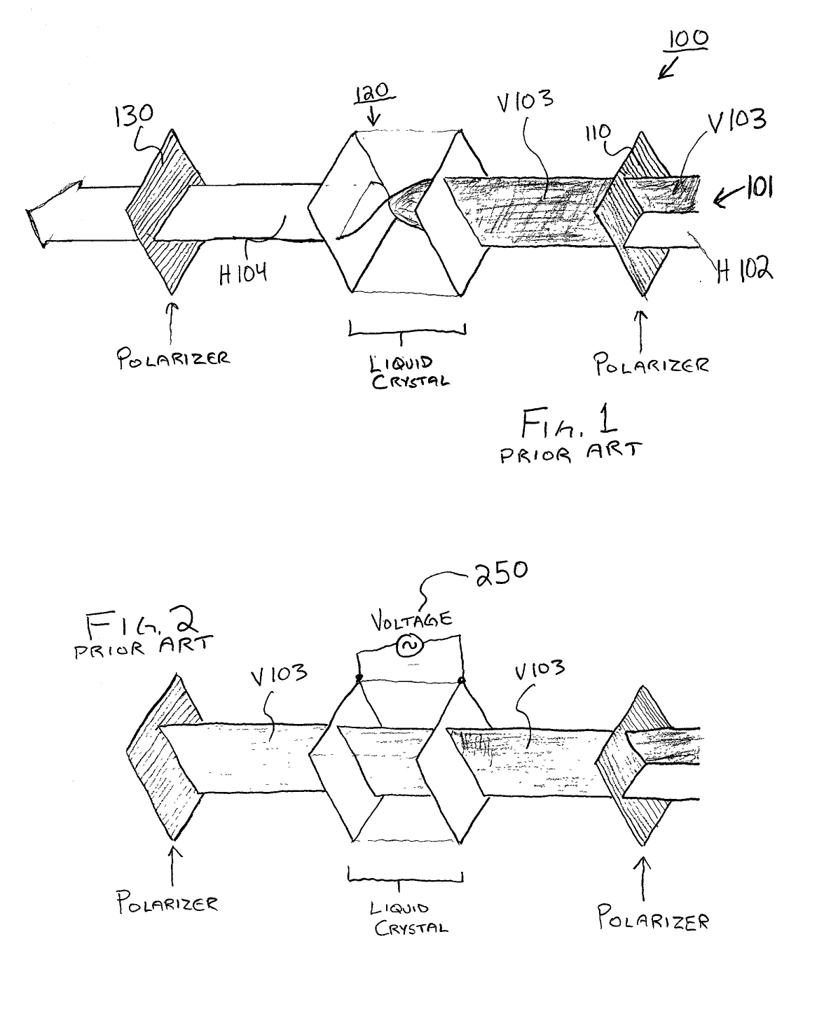

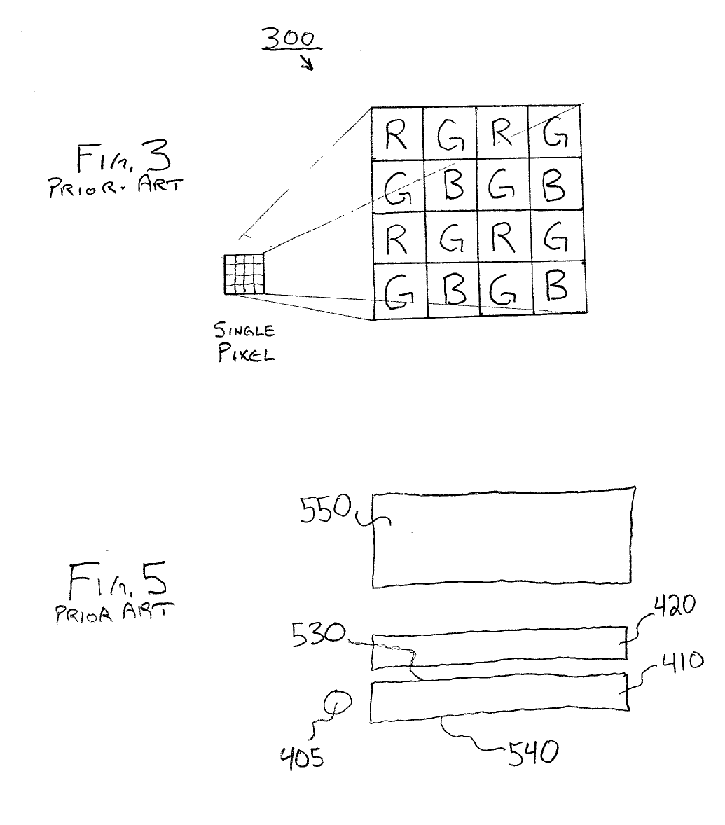

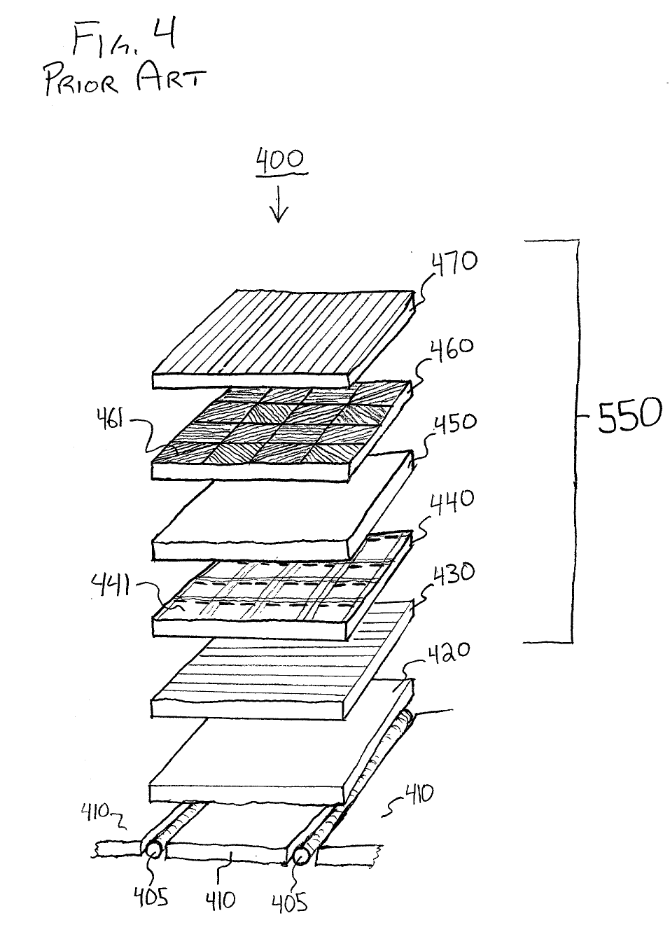

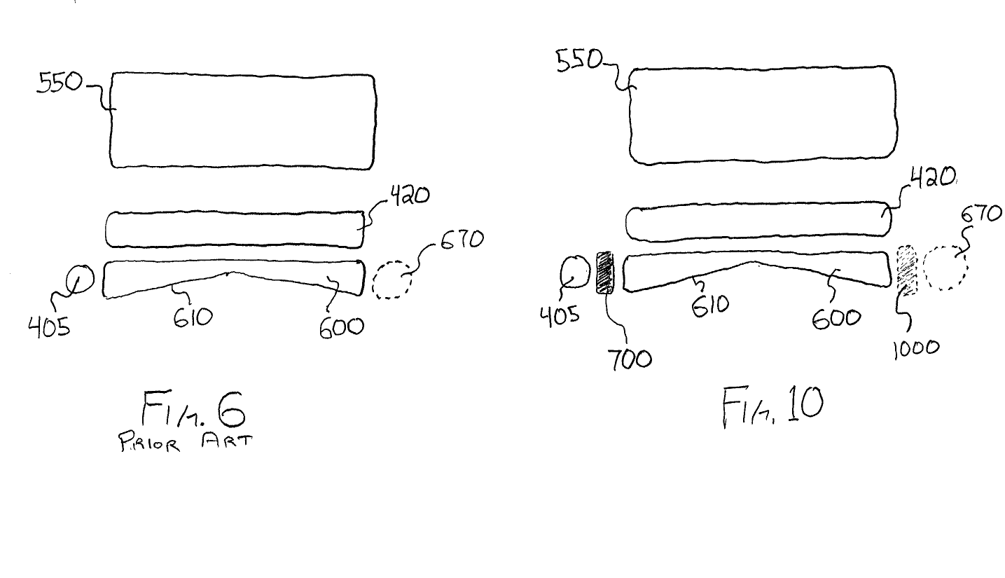

### DETAILED DESCRIPTION OF THE PRESENTLY PREFERRED EMBODIMENTS

In the present invention, a fluorescent layer is inserted between the light source and the light guide of an edge light type backlit LCD device. The fluorescent layer is stimulated by a pulse of light from the light source, causing it to emit light. After the light source is turned off, the fluorescent layer continues to emit light at a particular intensity and frequency for a certain period. The backlit LCD device may be color or grayscale.

One preferred embodiment is shown in FIG. 7, which is a schematic representation of a cross-section of an LCD device, where the LCD device may be color or grayscale. The LCD device has light source 405, light guide 410, diffuser 420, and liquid crystal matrix 550. The LCD device has a fluorescent layer 700 located between light source 405 and light guide 410.

Although shown as its own layer in FIG. 7, fluorescent layer 700 may be a coating on the side edge of light guide 410 or on the side of light source 405. Each time that light source 405 is turned on, fluorescent layer 700 becomes excited and begins to emit light. This emission of light continues for a time after light source 405 is turned off, thus continuing to provide a light source for light guide 410, diffuser 420, and liquid crystal matrix 550.

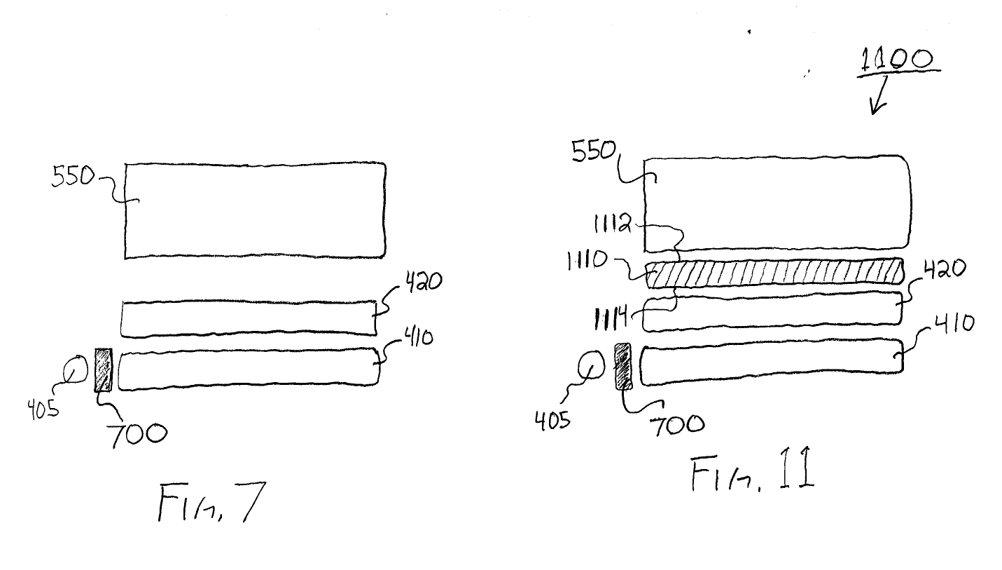

FIGS. 8 and 9 are schematic representations of the pulses a light source emits in a conventional LCD device and an LCD device according to an embodiment of the present invention, respectively. FIGS. 8 and 9 do not depict actual graphs of light pulses over time, but are presented to conceptually illustrate the operating principle of the present invention. In FIG. 8, pulse 801 is shown at the beginning of the graph, followed by pulse 802. The pulses are shown as curves because no light source can actually produce a pulse with straight edges like a square. From the start of pulse 801 to the start of pulse 802 is a single cycle. FIG. 8 depicts a duty cycle of about 25% because the light source is powering the pulse over about a quarter of a cycle.

In FIG. 9, the effects of adding fluorescent layer 700 to an LCD device are shown by florescent emissions 910 and 920. As pulse 801 stimulates fluorescent layer 700, the fluorescent material begins to emit light, as shown by the rising curve 911 of fluorescent emission 910. As pulse 801 dies out, the fluorescent emission 910 slows down and peaks at the point labelled 912, where the stored energy received by fluorescent layer 700 begins to be used up. The intensity of fluorescent emission 910 steadily decreases until about three quarters through the cycle, where fluorescent emission 910 stops. This process repeats indefinitely, as shown by the next pulse 802 and fluorescent emission 920.

Fluorescent emission 910 extends the period of time in which light is maintained under the liquid crystal matrix of the LCD device, thus mitigating the effects of pulsing on the human eye. Even though the duty cycle in FIG. 9 is about 25%, the effective duty cycle is about 75% because light is being emitted continuously during three quarters of the cycle. When there is an extended plateau of light emission rather than a sharp spike of a light pulse, the unwanted visual effects of pulsing on and off are diminished. Although fluorescent emission 910 is shown having a peak intensity at roughly three quarters of the peak intensity of pulse 801, it may be any value. Furthermore, the duration of fluorescence emission 910 is only illustrative, and might be longer or shorter in different embodiments. The relative height (peak intensity), length (duration of emission), and shape of the curve (rates of emission and decay) of the fluorescent emission depends on the quantity, constituent material, and construction of fluorescent layer 700.

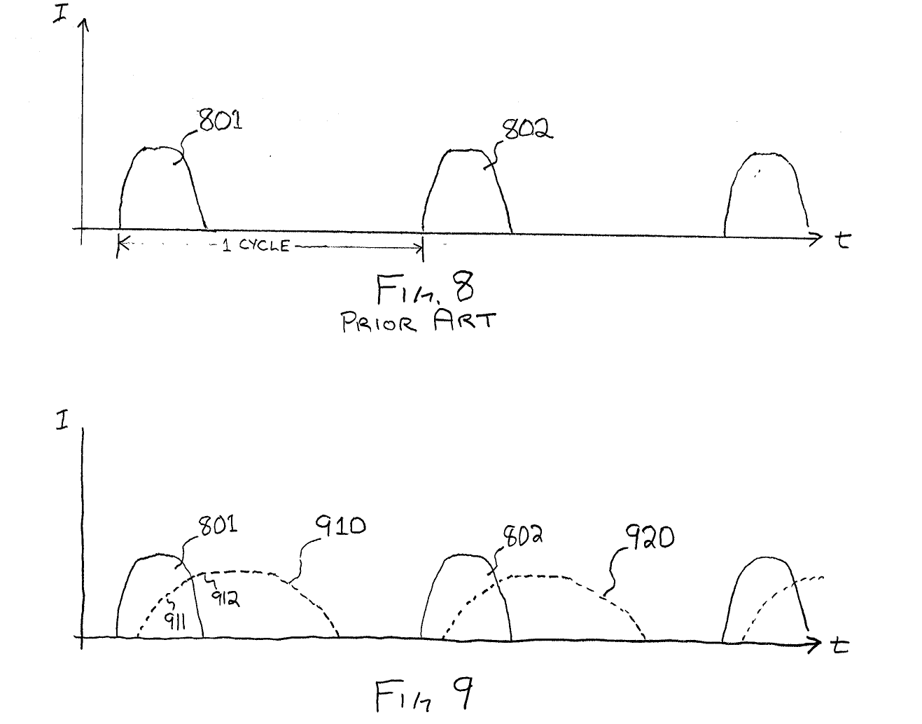

FIG. 10 is a schematic representation of a cross-section of an LCD device according to another preferred embodiment. The LCD device has a light source 405, double wedge shaped light guide 600, diffuser 420, liquid crystal matrix 550, and neighboring light source 670. The LCD device also has a fluorescent layer 700 located between light source 405 and double wedge-shaped light guide 600. In addition, a fluorescent layer 1000 is located on the other side of double wedge-shaped light guide 600 between neighboring light source 670 and double wedge-shaped light guide 600.

FIG. 11 shows yet another preferred embodiment of the present invention. LCD device 1100 is a transflective display, in which the screen is lit by both reflected ambient light and transmitted light from the light source. A transflector 1110 (transmissive reflector), which has one side 1112 that reflects ambient light coming in and another side 1114 that allows light from the light source 405 to pass through, is placed above light guide 410. Because transflector 1110 is placed above light guide 410, it is unlikely that ambient light will reach fluorescent layer 700.

Other lighting configurations are contemplated as embodiments of the present invention. For example, a reflective layer could be added underneath light guide 410, where the added reflective layer reflects both ambient light and light coming out of the bottom of light guide 410. As another example, the lighting configuration might allow the user to set the LCD device to either transfection or transmissive mode depending on the ambient light conditions.

Fluorescent layer 700 may be made from any material that can both fluoresce as described with reference to FIG. 9 and be placed in the appropriate location within an LCD device, such as the position of fluorescent layer 700 in FIGS. 7 and 8. The material of fluorescent layer 700 may be phosphor-based.

The above examples show the multiple advantages of the present invention. The light pulse duty cycle can be reduced without creating annoying visual effects. The shorter light pulse duty cycle in turn reduces power consumption of the LCD device, which is a great advantage for any portable equipment that is powered by batteries. The rate of light pulsing can be reduced without creating annoying visual effects. Specifically, the rate may be reduced below about 25 Hz, and possibly below about 16 Hz, depending on the characteristics of the added fluorescent material. The addition of florescence emissions makes it easier to adjust light power in a variety of ways. For example, a user can change the perceived brightness of an LCD device screen by adjusting the duty cycle, the pulse rate, and/or the peak intensity. Although it was possible to change the peak intensity in prior art LCD devices, there was no useful range over which one could change the duty cycle and/or pulse rate, only a minimum value for both, over which change was not substantially detectable. Therefore, it was not worthwhile in the prior art LCD devices to provide the user with the ability to change the duty cycle or the pulse rate. Furthermore, software control of power consumption can be much more fine-tuned in the present invention, for the same reasons.

Because the present invention balances out the stark on/off pulsing of the prior art, there is less of a problem of interference with ambient light in LCD devices which use reflected ambient light. In LCD devices which both transmit their own light and reflect ambient light, the pulse rate of the two light sources can sometimes interfere (e.g. when the ambient light is a fluorescent bulb), thus producing a variety of unwanted visual anomalies, from bright spots and black spots to the curtain effect (when a pattern of wavy lines appear on the screen). However, if the intensity of light emitted from the light guide no longer has peaks and troughs (which, when combined with the peaks and troughs of the ambient light, can be negated or amplified), but rather has an extended period of substantially balanced intensity, then the likelihood of interference effects caused by the combination of ambient light and light guide emitted light is substantially reduced.

The addition of fluorescent material has additional advantageous effects on the spectrum of the light which the light source produces to light the LCD matrix. Although white light is desirable as the backlighting source, typically the light source is concentrated at different wavelengths of the visible spectrum. The additional fluorescent layer of the present invention can be used to even out the distribution of wavelengths in the spectrum emitted by the light source. For example, some LCD devices use blue light LEDs as the light source. To even out the light distribution, a yellow fluorescent pigment powder is used to form a fluorescent pigment layer above the light guide. In embodiments of the present invention using blue LEDs as a light source, such pigment powder may be placed in the fluorescent layer adjacent to the light source itself

Although some prior art devices used fluorescent material, none of them used or placed the fluorescent material in the same manner as the present invention. For example, the fluorescent material in the Kumar device (mentioned in the Background section) was used to replace the color sub-pixels in a typical color LCD device. Thus, the fluorescent layer in Kumar device serves a completely different purpose than the present invention, and, because of this purpose, the Kumar device has a completely different construction. Namely, the fluorescent layer in Kumar is not really a layer, but a faceplate of thousands of different colored phosphor points. Furthermore, these phosphor points operate as the light source for the LCD display. Obviously, Kumar's configuration can only work in a color LCD device unlike the present invention, which can be implemented in a color or black and white LCD device. Furthermore, Kumar's device is limited to one light source, the faceplate of phosphor points, which, because it is integrated into the color liquid crystal matrix, in turn limits the manner in which the color liquid crystal matrix is constructed. In contrast, an LCD display according to the present invention can use a color or black and white liquid crystal matrix of almost any construction.

In contrast to the other prior art references in the Background section (Millikan, Chen, and Flynn), the fluorescent layer in the present invention is located between the light source and the light guide (such a comparison can not be made with the Kumar device, because the fluorescent layer in Kumar is the light source). Because the fluorescent layer according to the present invention is “vertical” with a height measured in millimeters, less material is required to form the fluorescent layer than if it was a horizontal fluorescent layer positioned above or below the light guide (as it is in the Millikan, Chen, and Flynn LCD devices). This also entails less expense and less manufacturing steps than adding a horizontal fluorescent layer above or below the light guide. Because of the fluorescent layer's close proximity to the light source, it receives more light energy from the light source and thus emits more light than if placed above or below the light guide. Furthermore, an LCD device according to the present invention could not cause the uneven spatial distribution of light intensity which may result from anomalies in a horizontal layer of fluorescent material.

Like Chen, the fluorescent layer according to the present invention can also help balance out the uneven spectrum of light emitted by the light source. However, the fluorescent layer according to the present invention solves problems caused by the location of the fluorescent layer in Chen and other prior art LCD devices with horizontal fluorescent layers. In these prior art devices, ambient light passes through the horizontal fluorescent layer twice: first when entering the display and, second, after being reflected off of a reflective surface under the horizontal fluorescent layer. This will cause distortion in the color distribution of the original ambient light which entered the display. Further, because the (reflected) ambient light passes through the horizontal fluorescent layer twice, the intensity of the (reflected) ambient light will be reduced. In contrast, the “vertical” fluorescent layer according to the present invention does not have this ambient light passing through it twice.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is also to be understood that the drawings are not necessarily drawn to scale but that they are merely conceptual in nature. It is the intention, therefore, to be limited only as indicated by the scope of the claims appended hereto.

What is claimed is:

1. A backlit liquid crystal display (LCD) device for use in a portable electronic device, comprising:
an edge light source for emitting pulses of light that provide backlighting for the LCD device, wherein a frequency of the emitted pulses of light is less than about 25 Hz;
a fluorescent layer positioned adjacent to said edge light source to receive pulses of light from the edge light source, being selected to emit a fluorescence emission after each light pulse, and being selected to allow pulses of light to pass therethrough;
a planar light guide positioned to receive, by means of an edge facing the edge light source, the pulses of light which pass through the fluorescent layer, being selected to redirect the received light out of a top surface, and being selected to balance an intensity distribution of the redirected light leaving the top surface, wherein the fluorescent layer is interposed between the edge light source and the edge facing the edge light source; and
a liquid crystal cell comprised of:
a rear polarizer positioned to receive the redirected light from the top surface of the planar light guide and being selected to allow only light of a first polarization to pass therethrough;
a liquid crystal element positioned to receive the light of the first polarization from the rear polarizer, being selected to change the first polarization of the received light to a polarization orthogonal to the first polarization when no voltage is applied to said liquid crystal element, and for passing the light of the first polarization therethrough when a voltage is applied to said liquid crystal element; and
a front polarizer positioned to receive light from the liquid crystal element and being selected to allow only light of a second polarization to pass therethrough.

2. The backlit LCD device of claim 1, wherein a width of the planar light guide decreases as a distance from the edge light source increases so that a more uniform distribution of redirected light intensity is produced as the redirected light exits the planar light guide.

3. The backlit LCD device of claim 1, wherein the fluorescent layer comprises:
fluorescent material being selected to balance an intensity distribution of a spectrum of the pulses of light.

4. A backlit liquid crystal display (LCD) device comprising:
an edge light source for emitting pulses of light that provide backlighting for the LCD device;
a fluorescent layer positioned to receive pulses of light from the edge light source, being selected to emit a fluorescence emission after each light pulse, and being selected to allow pulses of light to pass therethrough; and
a planar light guide positioned to receive, by means of an edge facing the edge light source, the pulses of light which pass through the fluorescent layer, being selected to redirect the received light out of a top surface, and being selected to balance an intensity distribution of the redirected light;
wherein the fluorescent layer is interposed between the edge light source and the planar light guide.

5. The backlit LCD device of claim 4, wherein the edge light source comprises a cold cathode fluorescent lamp, a hot cathode fluorescent lamp, a light emitting diode (LED), or an electroluminescent element.

6. The backlit LCD device of claim 4, wherein the planar light guide comprises a substantially transparent polymer or glass.

7. The backlit LCD device of claim 6, wherein the substantially transparent polymer comprises polymethyl methacrylate (PMMA), polystyrene, styrene-acrylonitrile, or polycarbonate.

8. The backlit LCD device of claim 4, wherein the backlit LCD device is a grayscale display device or a color display device.

9. The backlit LCD device of claim 4, wherein the backlit LCD device is an active matrix display device or a passive matrix display device.

10. The backlit LCD device of claim 4, wherein a frequency of the pulses of light emitted from the edge light source is less than about 25 Hz.

11. The backlit LCD device of claim 4, wherein a frequency of the pulses of light emitted from the edge light source is less than about 16 Hz.

12. The backlit LCD device of claim 4, further comprising:
a transflector positioned to receive the redirected light from the top surface of the planar light guide, being selected to transmit the redirected light from the top surface of the planar light guide, and being selected to reflect ambient light from an environment of the backlit LCD device.

13. The backlit LCD device of claim 4, further comprising:
a reflective layer positioned to receive ambient light through the planar light guide from an environment of the backlit LCD device and being selected to reflect the ambient light back out through the planar light guide.

14. The backlit LCD device of claim 4, further comprising:
a rear polarizer positioned to receive the redirected light from the top surface of the planar light guide and being selected to allow only light of a first polarization to pass therethrough;
a liquid crystal element positioned to receive the light of the first polarization from the rear polarizer, being selected to change the first polarization of the received light to a polarization orthogonal to the first polarization when no voltage is applied to said liquid crystal element, and being selected to pass the light of the first polarization therethrough when a voltage is applied to said liquid crystal element; and
a front polarizer positioned to receive light from the liquid crystal element and being selected to allow only light of a second polarization to pass therethrough.

15. The backlit LCD device of claim 14, wherein the second polarization is either orthogonal to the first polarization or the same as the first polarization.

16. The backlit LCD device of claim 4, wherein the backlit LCD device is used as a display screen in a portable electronic device.

17. The backlit LCD device of claim 16, wherein the portable electronic device is a laptop computer, a personal digital assistant (PDA), or a cellular telephone.

18. The backlit LCD device of claim 4, wherein the fluorescent layer comprises:
fluorescent material for balancing an intensity distribution of a spectrum of the pulses of light.

19. The backlit LCD device of claim 4, wherein the edge light source is located adjacent to the planar light guide.

20. The backlit LCD device of claim 19, wherein a width of the planar light guide decreases as a distance from the edge light source increases in order to provide a more uniform distribution of redirected light intensity as the redirected light exits the planar light guide.
